(19) United States
(12) Patent Application Publication
(10) Pub. No.: US 2013/0025782 A1
(43) Pub. Date: Jan. 31, 2013

(54) METHOD FOR MANUFACTURING WIRING SUBSTRATE

(71) Applicants: Kazunaga HIGO, Iida-shi (JP); Takuya TORII, Komaki-shi (JP); Daisuke YAMASHITA, Komaki-shi (JP)

(72) Inventors: Kazunaga HIGO, Iida-shi (JP); Takuya TORII, Komaki-shi (JP); Daisuke YAMASHITA, Komaki-shi (JP)

(73) Assignee: NGK SPARK PLUG CO., LTD., Nagoya-shi (JP)

(21) Appl. No.: 13/551,979

(22) Filed: Jul. 18, 2012

(30) Foreign Application Priority Data
Jul. 25, 2011 (JP) 2011-161876
Jan. 26, 2012 (JP) 2012-013904

(51) Int. Cl. B32B 37/14

(52) U.S. Cl. 156/306.6

(57) ABSTRACT

A method for manufacturing a wiring substrate having excellent connection reliability which has a front surface and a back surface and allows a semiconductor chip to be mounted on the front surface is provided. The method includes a step of forming build-up layers on a front side toward the front surface and a back side toward the back surface, respectively, by laminating one or more conductive layers and one or more resin insulation layers, the build-up layers on the front and back sides having at least one connection terminal on their surfaces, and a step of forming a first solder resist layer by laminating a first solder resist film on the build-up layer on the front side, and forming a second solder resist layer by laminating a second solder resist film thicker than the first solder resist layer on the build-up layer on the back side.

### CROSS REFERENCE TO RELATED APPLICATIONS

The present application claims priority from Japanese Patent Application No. 2011-161876, which was filed on Jul. 25, 2011, and Japanese Patent Application No. 2012-013904, which was filed on Jan. 26, 2012, the disclosures of which are herein incorporated by reference in their entirety.

### BACKGROUND OF THE INVENTION

1. Field of the Invention

The present invention relates to a method for manufacturing a wiring substrate. More particularly, the invention relates to a method for manufacturing a wiring substrate which allows a semiconductor chip to be mounted on its front side and is mounted on a motherboard, a socket, or the like via its back side.

2. Description of Related Art

There are various kinds of wiring substrates. For example, a certain wiring substrate has connection terminals on its front surface for connection to a semiconductor chip, and connection terminals on its back surface for connection to a motherboard, a socket, or the like (hereinafter referred to as a “motherboard or the like”). Such a wiring substrate is usually configured as follows. A build-up layer is formed on each of the front and back surfaces of a core substrate by alternatingly laminating conductive layers and resin insulation layers, and solder resist layers are formed on the respective build-up layers in such a manner that portions to be soldered, such as connection terminals, are exposed (refer to, for example, Patent Document 1).

### RELATED ART DOCUMENTS

### Patent Documents

Patent Document 1 is Japanese Patent Application Laid-Open (kokai) No. 2009-206446.

### BRIEF SUMMARY OF THE INVENTION

Conventionally, a semiconductor chip and a wiring substrate are connected generally through flip-chip bonding; i.e., by means of projecting terminals called solder bumps arranged in an array. However, in recent years, in association with tendency toward higher integration and higher densification of semiconductor chips, connection by use of Cu pillars, which enable high-density mounting of connection terminals, has been employed for connection of a semiconductor chip and a wiring substrate.

In a conventional wiring substrate, since solder resist layers are laminated on the respective build-up layers by a screen printing process or a roll coater process, the solder resist layers have the same thickness between the front surface and the back surface of the wiring substrate. However, when the solder resist layer on the front side is thick, the Cu pillars may fail to reach the connection terminals, potentially resulting in defective contact. Thus, in the case of use of Cu pillars for connection between a semiconductor chip and a wiring substrate, the solder resist layer must be rendered thin. By contrast, the wiring substrate and a motherboard or the like are connected via solder balls formed on respective connection terminals exposed from corresponding openings of the solder resist layer on the back side. In such a BGA (Ball Grid Array) substrate, in which solder balls are formed on the respective connection terminals, in order to form solder balls on the respective connection terminals in a reliably connected manner, the solder resist layer must be thick to a certain extent. If the solder resist layer is thin, the solder balls will fail to be formed properly, resulting in deterioration in connection reliability.

That is, when the solder resist layers are thick, connection reliability between the semiconductor chip and the wiring substrate deteriorates, whereas when the solder resist layers are thin, connection reliability between the wiring substrate and the motherboard or the like deteriorates.

The present invention has been conceived to cope with the above circumstances, and an object of the invention is to provide a method for manufacturing a wiring substrate having excellent connection reliability.

To achieve the above object, the present invention provides a method for manufacturing a wiring substrate which has a front surface and a back surface and allows a semiconductor chip to be mounted on the front surface. The method comprises a step of forming build-up layers on a front side toward the front surface and a back side toward the back surface, respectively, by laminating one or more conductive layers and one or more resin insulation layers, the build-up layer on the front side having at least one connection terminal on its surface, the build-up layer on the back side having at least one connection terminal on its surface, and a step of forming a first solder resist layer by laminating a first solder resist film on the build-up layer on the front side, and forming a second solder resist layer by laminating a second solder resist film thicker than the first solder resist layer on the build-up layer on the back side.

According to the present invention, the first solder resist film is laminated on the build-up layer on the front side, thereby forming the first solder resist layer, and the second solder resist film thicker than the first solder resist layer is laminated on the build-up layer on the back side, thereby forming the second solder resist layer. Therefore, the method can manufacture a wiring substrate having excellent reliability in connection to a semiconductor chip and to a motherboard or the like.

Also, since the solder resist layer is formed by laminating the solder resist film on the build-up layer, as compared with the case where solder resist is applied onto the build-up layer, the formed solder resist layer has a uniform thickness. This improves reliability in connection to a semiconductor chip and to a motherboard or the like. Also, solder resist in the form of film provides convenience in handling and facilitates impartment of different thicknesses to the solder resist layers on the front and back sides.

In an embodiment of the present invention, a first opening may be formed in the first solder resist layer for exposing the outer and side surfaces of the at least one connection terminal of the build-up layer on the front side, and a second opening may be formed in the second solder resist layer for partially exposing the outer surface of the at least one connection terminal of the build-up layer on the back side.

In this embodiment of the present invention, the opening formed in the solder resist layer on the front side of the wiring substrate where a semiconductor chip is connected is of the so-called NSMD (non-solder mask defined) type, in which the outer and side surfaces of the connection terminal are exposed, whereas the opening formed in the solder resist layer on the back side of the wiring substrate where a motherboard or the like is connected are of the so-called SMD (solder mask defined) type, in which the outer surface of the connection terminal is exposed.

Since the front side of the wiring substrate is connected to Cu pillars of a semiconductor chip, in order to cope with the fine pitch of the Cu pillars, the opening formed in the solder resist layer can be of the NSMD type. However, the back side of the wiring substrate does not require such a fine-pitch arrangement of connection terminals as in the case of the front side. Therefore, through employment of the SMD type, which provides high connection reliability, for the openings formed in the solder resist layer on the back side of the wiring substrate, reliability in connection to a motherboard or the like can be improved.

In another embodiment of the present invention, a third solder resist layer may be formed by laminating a third solder resist film on the first solder resist layer, and a third opening may be formed in the third solder resist layer in such a manner as to surround a mounting region for the semiconductor chip.

If the solder resist layer laminated on the build-up layer is thin, the conductive layer of the build-up layer may be exposed. Meanwhile, in order to ensure reliability in connection to a semiconductor chip to be mounted on the surface of the wiring substrate, in the mounting region for the semiconductor device, the solder resist layer must be thin. Therefore, by means of another solder resist layer being laminated in a region other than the semiconductor chip mounting region, the thickness of the solder resist layer can be increased, thereby lowering the risk of exposure of the conductive layer of the build-up layer.

In still another embodiment of the present invention, in formation of the third solder resist layer, the third solder resist film may be laminated on the first solder resist layer having the first opening.

In formation of the third solder resist layer, by means of the third solder resist film being laminated on the first solder resist layer having the first opening, the manufacturing process is simplified, thereby reducing the manufacturing cost for the wiring substrate.

In a another embodiment of the present invention, in the step of forming the build-up layers, the one or more conductive layers and the one or more resin insulation layers are laminated on a front surface and on a back surface of a core substrate.

As described above, the present invention can provide a method for manufacturing a wiring substrate having excellent connection reliability.

### BRIEF DESCRIPTION OF THE DRAWINGS

Illustrative aspects of the invention will be described in detail with reference to the following figures wherein:

FIG. 1 is a plan view (front side view) showing a wiring substrate according to an embodiment of the present invention.

FIG. 2 is a back view (back side view) showing the wiring substrate according to the embodiment.

FIG. 3 is a sectional view showing the wiring substrate according to the embodiment.

FIG. 4 is an enlarged fragmentary sectional view showing the wiring substrate according to the embodiment.

FIG. 5 is a plan view (front side view) showing a wiring substrate according to a second embodiment of the present invention.

FIG. 6 is an enlarged fragmentary sectional view showing the wiring substrate according to the second embodiment.

### DETAILED DESCRIPTION OF EXEMPLARY EMBODIMENTS OF THE INVENTION

An embodiment of the present invention will be described in detail with reference to the drawings. The embodiment is described below while mentioning a wiring substrate configured such that build-up layers are formed on a core substrate. However, no particular limitation is imposed on the configuration of a wiring substrate, so long as one main surface of the wiring substrate is connected to a semiconductor chip, and the other main surface of the wiring substrate is connected to a motherboard, a socket, or the like. For example, a wiring substrate may not have a core substrate.

### Embodiment

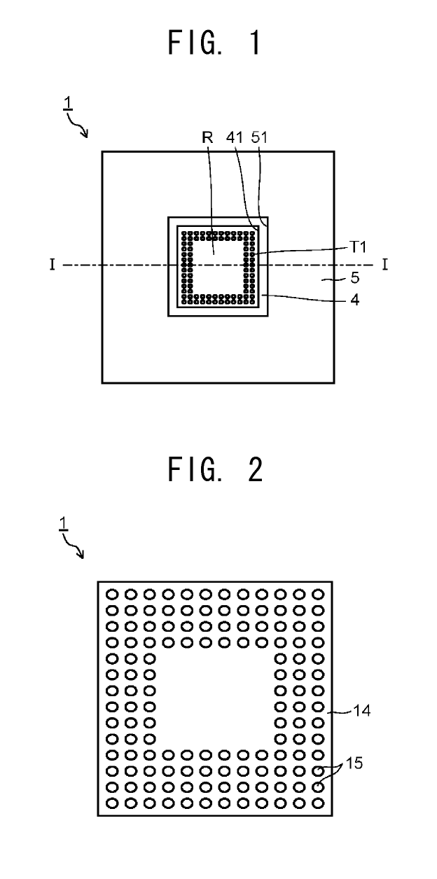

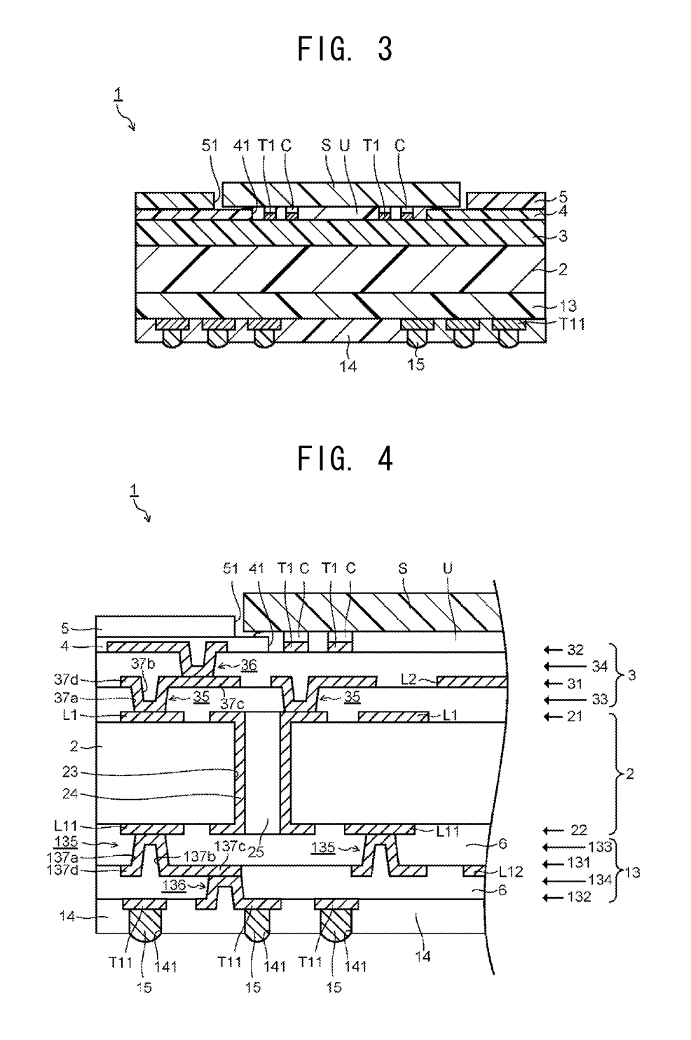

FIG. 1 is a plan view (front side view) showing a wiring substrate 1 according to the present embodiment. FIG. 2 is a back view (back side view) showing the wiring substrate 1. FIG. 3 is a sectional view of the wiring substrate 1 taken along line I-I of FIG. 1. FIG. 4 is an enlarged fragmentary sectional view showing the wiring substrate 1. FIGS. 3 and 4 are sectional views showing the wiring substrate 1 on which a semiconductor chip S is mounted. In the following description, a side on which the semiconductor chip S is connected is referred to as the front side, and a side on which a motherboard, a socket, or the like (hereinafter referred to as a “motherboard or the like”) is connected is referred to as the back side.

Configuration of Wiring Substrate 1

The wiring substrate 1 shown in FIGS. 1 to 4 includes a core substrate 2, build-up layers 3 (front side) and 13 (back side) formed on the front side and the back side, respectively, of the core substrate 2, a solder resist layer 4 (front side) formed on the build-up layer 3, a solder resist layer 14 (back side) formed on the build-up layer 13, and a solder resist layer 5 formed on the solder resist layer 4.

The core substrate 2 is a platelike resin substrate formed of a heat resistant resin plate (e.g., a bismaleimide-triazine resin plate), a fiber-reinforced resin plate (e.g., a glass-fiber-reinforced epoxy resin), or the like. Core conductive-layers 21 and 22, which form metal wirings L1 and L11, are formed on the front surface and the back surface, respectively, of the core substrate 2. The core substrate 2 has through-holes 23 formed by drilling or the like. A through-hole conductor 24 is formed on the inner wall surface of each of the through-holes 23 for establishing electrical communication between the core conductive-layers 21 and 22. Furthermore, the through-holes 23 are filled with a resin filler 25 of epoxy resin or the like.

Configuration on Front Side

The build-up layer 3 is composed of conductive layers 31 and 32 and resin insulation layers 33 and 34, which are laminated on the front side of the core substrate 2. The resin insulation layer 33 is formed from a thermosetting resin composition. The conductive layer 31, which forms metal wiring L2, is formed on the front surface of the resin insulation layer 33. The resin insulation layer 33 has vias 35 for electrically connecting the core conductive-layer 21 and the conductive layer 31. The resin insulation layer 34 is formed from a thermosetting resin composition. The conductive layer 32 having one or more connection terminals T1 is formed on the surface of the resin insulation layer 34. The resin insulation layer 34 has vias 36 for electrically connecting the conductive layer 31 and the conductive layer 32.

Each of the vias 35 and 36 has a via hole 37a and a via conductor 37b provided on the inner circumferential surface of the via hole 37a, a via pad 37c provided in such a manner as to electrically communicate on a bottom side with the via conductor 37b, and a via land 37d projecting outward from an opening edge of the via conductor 37b on a side opposite the via pad 37c. The connection terminals T1 are adapted for connection to the semiconductor chip S. The connection terminals T1 are so-called peripheral electrodes and are disposed along the inner periphery of a mounting region R for the semiconductor chip S. The semiconductor chip S is mounted on the wiring substrate 1 through establishment of electrical connection to the connection terminals T1. In mounting the semiconductor chip S on the wiring substrate 1, solder applied to Cu pillars C (i.e., pillar terminals) of the semiconductor chip S is reflowed, thereby establishing electrical connection between the connection terminals T1 and the Cu pillars C of the semiconductor chip S.

The solder resist layer 4 is formed by laminating a solder resist film on the surface of the build-up layer 3. As mentioned above, in the present embodiment, the Cu pillars C of the semiconductor chip S are connected to the corresponding connection terminals T1 of the wiring substrate 1. Thus, the solder resist layer 4 is formed thin according to the length of the Cu pillars C. The solder resist layer 4 has, for example, a maximum thickness of 15 μm and an average thickness of 8 μm. The average thickness is the average of solder resist layer thicknesses measured at a plurality of points (e.g., at intervals of one mm).

The solder resist layer 4 has an opening 41 for exposing the connection terminals T1 arranged along the inner periphery of the mounting region R for the semiconductor chip S. Through the opening 41, the outer and side surfaces of the connection terminals T1 are exposed from the solder resist layer 4. That is, the opening 41 of the solder resist layer 4 is of the NSMD type, which exposes the outer and side surfaces of the connection terminals T1 arranged at a fine pitch.

The solder resist layer 5 is formed by laminating a solder resist film on the surface of the solder resist layer 4. The solder resist layer 5 has an opening 51 which surrounds the mounting region R for the semiconductor chip S. By means of the solder resist layer 5 being formed on the solder resist layer 4, exposure of the underlying conductive layer 32 can be prevented. Also, the solder resist layer 5 can prevent outflow of underfill U which is charged into a space around the mounted semiconductor chip S, from inside the mounting region R for the semiconductor chip S. The solder resist layer 5 has a thickness of, for example, 15 μm to 20 μm.

By virtue of use of solder resist films to form the solder resist layers 4 and 5, the solder resist layer thickness can be maintained uniform as compared with the case of application of solder resist ink (e.g., varnish).

Configuration on Back Side

The build-up layer 13 is composed of conductive layers 131 and 132 and resin insulation layers 133 and 134, which are laminated on the back side of the core substrate 2. The resin insulation layer 133 is formed from a thermosetting resin composition. The conductive layer 131, which forms metal wiring L12, is formed on the back surface of the resin insulation layer 133. The resin insulation layer 133 has vias 135 for electrically connecting the core conductive-layer 22 and the conductive layer 131. The resin insulation layer 134 is formed from a thermosetting resin composition. The conductive layer 132 having one or more connection terminals T11 is formed on the surface of the resin insulation layer 134. The resin insulation layer 134 has vias 136 for electrically connecting the conductive layer 131 and the conductive layer 132.

Each of the vias 135 and 136 has a via hole 137a and a via conductor 137b provided on the inner circumferential surface of the via hole 137a, a via pad 137c provided in such a manner as to electrically communicate on a bottom side with the via conductor 137b, and a via land 137d projecting outward from an opening edge of the via conductor 137b on a side opposite the via pad 137c. The connection terminals T11 are utilized as back-surface lands (e.g., BGA pads) for connecting the wiring substrate 1 to a motherboard or the like. The connection terminals T11 are formed in an outer peripheral region around a substantially central region of the wiring substrate 1 in such a rectangular array around the substantially central region.

The solder resist layer 14 is formed by laminating a solder resist film on the surface of the build-up layer 13. The solder resist layer 14 has openings 141 for partially exposing the surfaces of the connection terminals T11. Thus, the connection terminals T11 are in such a state that their outer surfaces are partially exposed from the solder resist layer 4 through the respective openings 141. That is, the openings 141 of the solder resist layer 14 are of the SMD type, which partially exposes the outer surfaces of the connection terminals T11. In contrast to the opening 41 of the solder resist layer 4, the openings 141 of the solder resist layer 14 are formed individually for the connection terminals T11.

As mentioned above, in the present embodiment, the pitch of the connection terminals T11 is not so fine as that of the connection terminals T1. Thus, the openings 141 of the solder resist layer 14 can be of the SMD type such that the outer surfaces of the connection terminals T11 are partially exposed. By virtue of employment of the SMD-type openings 141 of the solder resist layer 14, reliability in connection to a motherboard or the like can be improved.

The solder resist layer 14 is thicker than the solder resist layer 4. The solder resist layer 14 has a thickness of, for example, 25 μm. The employment of the thick solder resist layer 14 improves the connection reliability of solder balls 15 which are formed on the respective connection terminals T11 by a printing process. Also, the employment of the thick solder resist layer 14 prevents exposure of the underlying conductive layer 132.

Furthermore, the solder balls 15 are formed from solder which contains substantially no lead, such as Sn—Ag, Sn—Cu, Sn—Ag—Cu, or Sn—Sb, in the respective openings 141 in such a manner as to be electrically connected to the respective connection terminals T11. The wiring substrate 1 is mounted on a motherboard or the like by reflowing the solder balls 15 thereof.

By virtue of use of a solder resist film to form the solder resist layer 14, the solder resist layer thickness can be maintained uniform as compared with the case of application of solder resist ink (e.g., varnish).

Method for Manufacturing Wiring Substrate

Next, a method for manufacturing the wiring substrate 1 of the present invention will be described. The present embodiment employs a semi-additive process for forming the build-up layers 3 and 13. However, other processes (e.g., a subtractive process) may be used to form the build-up layers 3 and 13.

Core substrate preparation processThere is prepared a copper clad laminate configured such that a plate-like resin substrate has copper foils affixed to its front and back surfaces, respectively. Through-holes which will become the through-holes 23 are drilled in the copper clad laminate at predetermined positions. Then, the copper clad laminate is subjected to electroless copper plating and copper electroplating, thereby forming the through-hole conductors 24 on the inner walls of the through-holes 23, and copper plating layers on the opposite sides of the copper clad laminate.

Subsequently, the through-hole conductors 24 are filled with the resin filler 25, such as epoxy resin. Furthermore, copper platings formed on the respective copper foils on the opposite sides of the copper clad laminate are etched to desired patterns so as to form the core conductive-layers 21 and 22, which form the respective metal wirings L1 and L11, on the front and back surfaces, respectively, of the copper clad laminate, thereby yielding the core substrate 2. Desirably, after the step of forming the through-holes 23, a desmearing process is performed for eliminating smear from processed portions.

Build-Up Process

Insulating resin films which contain an epoxy resin as a main component and will become the resin insulation layers 33 and 133 are overlaid on the front and back surfaces, respectively, of the core substrate 2. The resultant laminate is subjected to pressure and heat by use of a vacuum thermocompression press, thereby pressure bonding the insulating resin films to the core substrate 2 while the insulating resin films are heat-cured. Next, the via holes 37a and 137a are formed in the resin insulation layers 33 and 133, respectively, through laser irradiation by use of a conventionally known laser machining apparatus (e.g., laser drilling process).

Then, after the surfaces of the resin insulation layers 33 and 133 are roughened, electroless copper plating is performed, thereby forming electroless copper plating layers on the resin insulation layers 33 and 133, respectively, including the inner walls of the via holes 37a and 137a. Next, photo resist is laminated on the electroless copper plating layers formed respectively on the resin insulation layers 33 and 133, followed by exposure and development to form plating resist in a desired pattern.

Subsequently, with the plating resist being used as a mask, copper electroplating is performed, thereby yielding copper plating in a desired pattern. Next, the plating resist is removed for removing the electroless copper plating layer which underlies the plating resist, thereby forming the conductive layers 31 and 131, which form the respective metal wirings L2 and L12. At this time, the vias 35 and 135 composed of the via conductors 37b and 137b, the via pads 37c and 137c, and the via lands 37d and 137d are also formed.

Next, insulating resin films which contain an epoxy resin as a main component and will become the resin insulation layers 34 and 134 are overlaid on the conductive layers 31 and 131, respectively. The resultant laminate is subjected to pressure and heat by use of a vacuum thermocompression press, thereby pressure bonding the insulating resin films to the conductive layers 31 and 131 while the insulating resin films are heat-cured. Next, the via holes 37a and 137a of vias 36 and 136 are formed in the resin insulation layers 34 and 134, respectively, through laser irradiation by use of a conventionally known laser machining apparatus (e.g., laser drilling process).

Then, by a semi-additive process employed in formation of the conductive layers 31 and 131, the conductive layers 32 and 132 having the connection terminals T1 and T11, respectively, are formed respectively on the resin insulation layers 34 and 134 in which the via holes 37a and 137a of vias 36 and 136 are formed respectively.

Solder Resist Layer Forming Process

Solder resist films are press-laminated respectively on the build-up layers 3 and 13 having the connection terminals T1 and T11 on their respective surfaces. The solder resist film to be laminated on the build-up layer 13 is thicker than the solder resist film to be laminated on the build-up layer 3.

The solder resist films laminated on the build-up layers 3 and 13 are subjected to exposure and development, thereby forming the solder resist layer 4 having the NSMD-type opening 41 for exposing the end surfaces (e.g., outer surfaces) and side surfaces of the connection terminals T1, and the solder resist layer 14 having the SMD-type openings 141 for partially exposing the end surfaces (e.g., outer surfaces) of the connection terminals T11.

Next, a solder resist film is press-laminated on the solder resist layer 4. The solder resist film is subjected to exposure and development, thereby forming the solder resist layer 5 having the opening 51 which surrounds the mounting region R for the semiconductor chip S.

Back End Process

Solder paste is applied, by solder printing, to the outer surfaces of the connection terminals T11 exposed from the openings 141 formed in the solder resist layer 14. Subsequently, the applied solder paste is reflowed at a predetermined temperature for a predetermined time, thereby forming the solder balls 15 electrically connected to the connection terminals T11.

Mounting Semiconductor Chip S

The semiconductor chip S is mounted on the wiring substrate 1 by reflowing solder applied to the Cu pillars C of the semiconductor chip S. Subsequently, the underfill U is charged into a space between the semiconductor chip S and the wiring substrate 1.

Mounting on Motherboard or the Like

The wiring substrate 1 is mounted on a motherboard or the like by reflowing the solder balls 15 of the wiring substrate 1.

### Modification of Embodiment

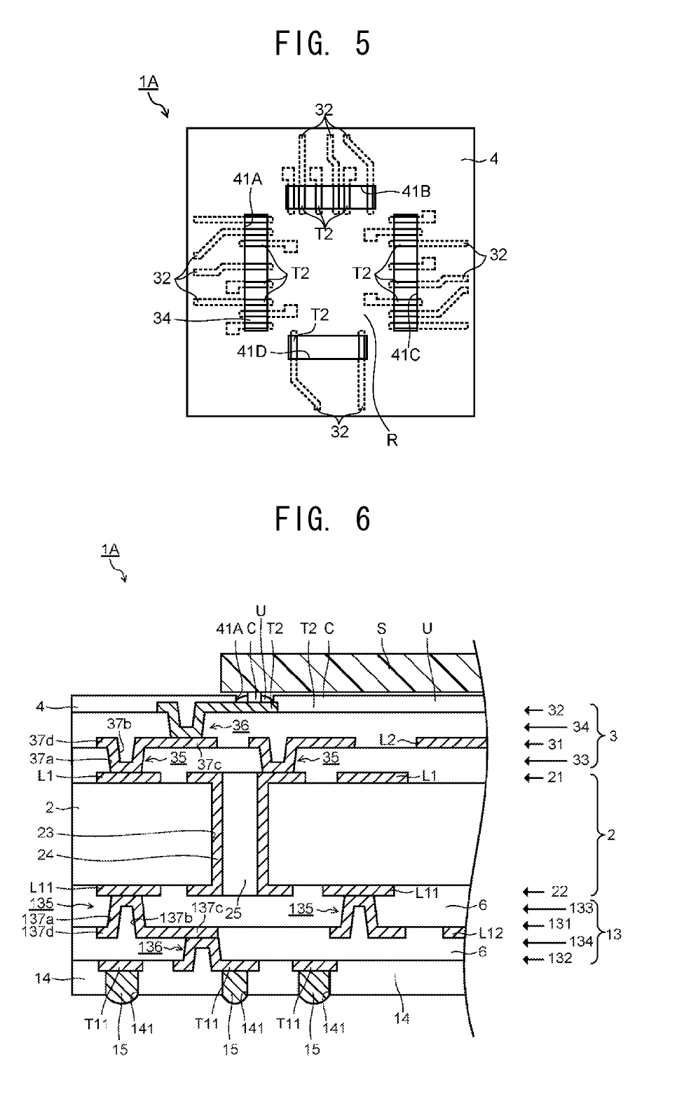

FIG. 5 is a plan view (front side view) showing a wiring substrate 1A according to a modification of the embodiment. FIG. 6 is an enlarged fragmentary sectional view showing the wiring substrate 1A. FIG. 5 does not show the semiconductor chip S. The above embodiment has been described with reference to FIGS. 1 to 4 while mentioning the wiring substrate 1 having a single opening 41 which is formed in the solder resist layer 4 so as to expose the connection terminals T1 disposed along the inner periphery of the mounting region R for the semiconductor chip S.

However, as shown in FIGS. 5 and 6, the following configuration may be employed: connection terminals T2 to be connected to the semiconductor chip S each have a strip shape, and a plurality of openings 41A to 41D for partially exposing the strip connection terminals T2 are formed at a peripheral portion of the mounting region R for the semiconductor chip S. Although unillustrated in FIGS. 5 and 6, the following configuration may be employed: a solder resist film may be laminated on the surface of the solder resist layer 4 so as to provide the solder resist layer 5, and the opening 51 which surrounds the mounting region R for the semiconductor chip S may be formed in the solder resist layer 5. Since other configurational features are identical to those of the wiring substrate 1 having been described with reference to FIGS. 1 to 4, like configurational features are denoted by like reference numerals, and repeated description thereof is omitted.

### Example

Four samples labeled A to D shown below in Table 1 were prepared on the basis of the above-mentioned method for manufacturing the wiring substrate 1 and conducted an evaluation test on samples A to D. The connection terminals T1 to which the Cu pillars of a semiconductor chip are to be connected are formed at a pitch of 50 μm on the surface of the build-up layer 3. “Front SR layer thickness” appearing in Table 1 is the average thickness of the solder resist layer 4. “Back SR layer thickness” appearing in Table 1 is the average thickness of the solder resist layer 14.

TABLE 1
Specification of sample wiring substrates.

| | Sample A | Sample B | Sample C | Sample D |
|---|---|---|---|---|
| SR application | Ink | Ink | Film | Film |
| method | | | | |
| Front SR layer | 25 μm | 8 μm | 8 μm | 8 μm |
| thickness | | | | |
| Back SR layer | 25 μm | 8 μm | 8 μm | 25 μm |
| thickness | | | | |

First, samples A to D are described. The average thickness of each of the solder resist layers 4 and 14 is the average of thicknesses measured at intervals of 1 mm.

Sample A has the solder resist layers 4 and 14 formed through application of solder resist ink. The solder resist layers 4 and 14 have an average thickness of 25 μm and 25 μm, respectively.

Sample B has the solder resist layers 4 and 14 formed through application of solder resist ink. The solder resist layers 4 and 14 have an average thickness of 8 μm and 8 μm, respectively.

Sample C has the solder resist layers 4 and 14 formed through press-lamination of respective solder resist films. The solder resist layers 4 and 14 have an average thickness of 8 μm and 8 μm, respectively.

Sample D has the solder resist layers 4 and 14 formed through press-lamination of respective solder resist films. The solder resist layers 4 and 14 have an average thickness of 8 μm and 25 μm, respectively.

Table 2 shows the evaluation results of samples A to D prepared as mentioned above.

TABLE 2
Evaluation of sample wiring substrates.

| | Sample A | Sample B | Sample C | Sample D |
|---|---|---|---|---|
| SR forming | 100% | 50%(underlying | 100% | 100% |
| yield | | layer exposed) | | |
| Chip mounting | 50% | 100% | 100% | 100% |
| yield | | | | |
| Reliability | Pass | NG | NG | Pass |
| test result | | | | |

“SR forming yield” appearing in Table 2 indicates whether or not the solder resist layers 4 and 14 are properly formed on the build-up layers 3 and 13, respectively. Specifically, NG evaluation was made when the underlying conductive layer 32 (132) was exposed from the solder resist layer 4 (14).

“Chip mounting yield” appearing in Table 2 indicates reliability in connection to a semiconductor chip. Specifically, semiconductor chips were mounted on the respective wiring substrates of samples A to D. Then, a terminal-to-terminal continuity test was conducted. NG evaluation was made when continuity failed.

“Reliability test result” appearing in Table 2 indicates reliability in connection to a motherboard or the like. Specifically, the wiring substrates of samples A to D were connected to respective motherboards. Then, a terminal-to-terminal continuity test was conducted. NG evaluation was made when continuity failed.

As is confirmed from the results shown in Table 2, sample A has a “chip mounting yield” of 50%. This is for the following reason. Since the solder resist layer 4 formed on the front side of sample A is excessively thick relative to the length of the Cu pillars of the semiconductor chip, a normal connection fails to be established between the connection terminals of sample A and the Cu pillars of the semiconductor chip mounted on the sample A.

As is confirmed from the results shown in Table 2, sample B has an “SR forming yield” of 50%. This is for the following reason: since the solder resist layer 14 formed on the back side of sample B is thin, the underlying conductive layer 132 is exposed from the solder resist layer 14. Also, it is confirmed that sample B is evaluated as NG for “reliability test result.” This is for the following reason: since the solder resist layer 14 formed on the back side of sample B is thin, the solder balls 15 failed to be normally formed on the connection terminals T11.

As is confirmed from the results shown in Table 2, sample C is evaluated as NG for “reliability test result.” This is for the following reason: since the solder resist layer 14 formed on the back side of sample B is thin, the solder balls 15 failed to be normally formed on the connection terminals T11.

As is confirmed from the results shown in Table 2, sample D is evaluated as normal for all of “SR forming yield,” “chip mounting yield,” and “reliability test result.” That is, the manufacturing method of the present invention can manufacture a wiring substrate which exhibits excellent reliability in connection to a semiconductor chip and to a motherboard or the like.

While the present invention has been described in detail with reference to the embodiment, the present invention is not limited thereto. Various and numerous modifications and changes can be made without departing from the scope of the present invention. For example, although the above embodiment has been described while mentioning the wiring substrate 1 in the form of a BGA substrate, the present invention may be applied to a so-called PGA (Pin Grid Array) substrate or LGA (Land Grid Array) substrate, in which pins or lands are provided in place of the solder balls 15.

### DESCRIPTION OF REFERENCE NUMERALS

1: wiring substrate;
2: core substrate;
3, 13: build-up layer;
4, 5, 14: solder resist layer;
15: solder ball; 21, 22: core conductive-layer;
23: through-hole;
24: through-hole conductor;
25: resin filler; 31, 32. 131, 132: conductive layer;
33, 34, 133, 134: resin insulation layer;
35, 36, 135, 136: via;
37a, 137a: via hole;
37b, 137b: via conductor;
37c, 137c: via pad;
37d, 137d: via land;
41, 51, 141: opening;
L1, L2, L11, L12: metal wiring;
R: mounting region;
S: semiconductor chip; and
T1, T2, T11: connection terminal.

What is claimed is:

1. A method for manufacturing a wiring substrate which has a front surface and a back surface and allows a semiconductor chip to be mounted on the front surface, comprising:
forming build-up layers on a front side toward the front surface and a back side toward the back surface, respectively, by laminating one or more conductive layers and one or more resin insulation layers, the build-up layer on the front side having at least one connection terminal on its surface, the build-up layer on the back side having at least one connection terminal on its surface, and
forming a first solder resist layer by laminating a first solder resist film on the build-up layer on the front side, and forming a second solder resist layer by laminating a second solder resist film thicker than the first solder resist layer on the build-up layer on the back side.

2. The method for manufacturing a wiring substrate according to claim 1, further comprising:
forming a first opening in the first solder resist layer for exposing outer and side surfaces of the at least one connection terminal of the build-up layer on the front side; and
forming a second opening in the second solder resist layer for partially exposing an outer surface of the at least one connection terminal of the build-up layer on the back side.

3. The method for manufacturing a wiring substrate according to claim 2, further comprising:
forming a third solder resist layer by laminating a third solder resist film on the first solder resist layer, and
forming a third opening in the third solder resist layer in such a manner as to surround a mounting region for the semiconductor chip.

4. The method for manufacturing a wiring substrate according to claim 3, wherein forming the third solder resist layer is such that the third solder resist film is laminated on the first solder resist layer having the first opening.

5. The method for manufacturing a wiring substrate according to claim 1, wherein in forming the build-up layers, the one or more conductive layers and the one or more resin insulation layers are laminated on a front surface and on a back surface of a core substrate.
